(19) United States
(12) Patent Application Publication
(10) Pub. No.: US 2021/0053846 A1
(43) Pub. Date: Feb. 25, 2021

(54) METHOD FOR DEGRADING PHENOL IN INDUSTRIAL WASTEWATER WITH DUAL-FREQUENCY COMPOSITE ULTRASOUND

(71) Applicants: SOUTH CHINA UNIVERSITY OF TECHNOLOGY, Guangdong (CN); Guizhou Academy of Sciences, Guizhou (CN); Guangdong Pharmaceutical University, Guangdong (CN)

(72) Inventors: Shaoqi ZHOU, Guangdong (CN); Yongguang BEN, Guangdong (CN)

(73) Assignees: SOUTH CHINA UNIVERSITY OF TECHNOLOGY, Guangdong (CN); Guizhou Academy of Sciences, Guizhou (CN); Guangdong Pharmaceutical University, Guangdong (CN)

(21) Appl. No.: 16/997,946

(22) Filed: Aug. 20, 2020

(30) Foreign Application Priority Data
Aug. 20, 2019 (CN) 201910770263.3

(51) Int. Cl. C02F 1/36; C02F 1/66

(52) U.S. Cl. CPC C02F 1/36; C02F 2101/345; C02F 1/66

(57) ABSTRACT

The invention discloses a method for degrading phenol in industrial wastewater by a dual-frequency composite ultrasound, which belongs to the technical field of phenol degradation. The method adopts the dual-frequency composite ultrasound to perform ultrasonic treatment to a phenol solution to be degraded for 10-30 minutes. Degradation rate of phenol by the dual-frequency composite ultrasound can reach 83.74%, which is 45.23% and 51.11% higher than the degradation rates of a probe-type ultrasound alone and a tank-type ultrasound alone. Therefore, it can be clearly seen that the degradation effect of dual-frequency composite ultrasonic synergistic degradation of phenol in water is ideal.

### CROSS-REFERENCE TO RELATED APPLICATION

This application claims the priority benefit of China application serial no. 201910770263.3, filed on Aug. 20, 2019. The entirety of the above-mentioned patent application is hereby incorporated by reference herein and made a part of this specification.

### TECHNICAL FIELD

The invention relates to the field of phenol degradation, in particular to a method for degrading phenol in industrial wastewater with dual-frequency composite ultrasound.

### BACKGROUND

With the current rapid development of the national economy, my country's industrial wastewater discharge has also increased sharply. Due to the high cost of using existing treatment technology, many companies will discount the treatment link when they are not strictly supervised. When such wastewater containing a large amount of difficult-to-degrade organic pollutants is directly discharged into nature, it will be harmful to human health and survival. The environment poses a serious threat. How to deal with these toxic and refractory organic matters has become one of the difficulties in the research of water pollution prevention and control circles.

Phenol-containing wastewater is a kind of industrial wastewater with wide sources, large water volume, and serious harm. Phenol is a typical representative of aromatic compounds. It is a class of stable compounds. It is widely used in modern industry. It is widely used as antioxidants, non-ionic surfactants, plasticizers, and additives for industries in petroleum products, textile, paper-making, plastic, medicine, pesticide, paint, etc. A large amount of organic wastewater containing aromatic compounds is not easily decomposed after being discharged, and even if it is degraded, phenol will be produced. Phenol has certain toxicity and is not easily decomposed by bacteria or microorganisms, causing great pollution to the water environment. It is a typical toxic and harmful organic pollutant.

At present, common phenol-containing wastewater treatment methods include extraction, adsorption, electrocatalysis, ultrasonic degradation, critical water oxidation, and conventional oxidation, etc. The single-stage extraction rate can reach more than 95%, but the phenol content of the wastewater after extraction still does not meet the discharge standard, and the wastewater contains trace extractants, which may cause secondary pollution. Therefore, the N-503 extraction method is only treated as a primary recovery treatment when treating wastewater with a high concentration of phenol. In order to meet the discharge standard, a secondary biochemical treatment is required. The adsorption method mainly uses large pore size resin as the adsorbent, and the cost is relatively high. As a new technology that has developed rapidly in the past 10 years, electrocatalytic technology is widely used in organic wastewater treatment due to its wide application range and rapid and thorough oxidation treatment, especially for organic wastewater treatment that is more toxic to organisms or difficult to biodegrade. More and more attention from domestic and foreign researchers have been attracted due to its high processing efficiency, easy operation, easy automation, and no secondary pollution. In the ultrasonic degradation method, the power source of ultrasonic oxidation is acoustic cavitation. When ultrasonic waves of sufficient intensity (15 kHz-20 MHz) pass through the aqueous solution, in the half cycle of the acoustic wave negative pressure, the amplitude of the sound pressure exceeds the static pressure inside the liquid, and the cavitation core in the liquid Expansion rapidly. In the half-cycle of the positive acoustic pressure, the bubble burst again due to adiabatic compression, and the duration is about 0.1 μs. At the moment of rupture, a local high temperature and high pressure environment of about 5000 K and 100 MPa is generated, and a strong impact microjet with a velocity of 110 m/s is generated. The equipment used in the ultrasonic oxidation technology is a magnetoelectric or piezoelectric ultrasonic transducer, which generates ultrasonic waves through electromagnetic energy. Ultrasonic oxidation reaction conditions are mild, usually carried out at room temperature, and have low requirements for equipment. It is a pollution-free green treatment technology with broad application prospects. Supercritical Water Oxidation (SCWO) is still in the initial research stage in China. The oxidation method is mostly used for the treatment of low-concentration phenol-containing wastewater (<1000 mg/L).

Ultrasonic degradation is mainly carried out in three ways: one is pyrolysis in the cavitation bubbles generated during the ultrasonic process; the other is in the solution body or the cavitation bubble liquid film, which is attacked by the OH⁻ and H⁺ free radicals generated by the ultrasonic process and degraded; the third is the supercritical water oxidation formed in the cavitation process, so as to be degraded.

However, so far, the problem of low degradation rate when using ultrasonic degradation has not been solved.

### SUMMARY

The purpose of the present invention is to provide a method for degrading phenol in industrial wastewater with a dual-frequency composite ultrasound, so as to solve the problems in the prior art and improve an efficiency of ultrasonic degradation of phenol.

In order to achieve the above objectives, the present invention provides the following solutions:

The present invention provides a method for degrading phenol in industrial wastewater with a dual-frequency composite ultrasound, wherein a phenol solution to be degraded is subjected to ultrasonic treatment for 10-30 minutes, and the ultrasonic treatment is performed with the dual-frequency composite ultrasound.

Further, the dual-frequency composite ultrasound is a combination of a probe-type ultrasound and a tank-type ultrasound, and the probe-type ultrasound and the tank-type ultrasound are simultaneously emitted in a direction opposite to each other.

Further, a power of the probe-type ultrasound is 40-600 W.

Further, a power of the tank-type ultrasound is 40-600 W.

Further, an initial concentration of the phenol solution to be degraded is 2.00-10.00 mg/L.

Further, an initial pH of the phenol solution to be degraded is 8-12.

Further, the initial pH of the phenol solution to be degraded is adjusted by adding a pH regulator.

Further, the pH regulator is a sodium hydroxide solution or a sulfuric acid solution.

The present invention discloses the following technical effects:

In the present invention, by designing and studying the influences of the power of the ultrasound, the initial concentration of the phenol solution, and the initial pH of the phenol solution on the degradation of phenol, an optimal process for degrading phenol in water with the dual-frequency composite ultrasound is obtained. With the dual-frequency composite ultrasound, degradation of phenol has a degradation enhancement effect and the degradation technology is enhanced, which can provide a reference for the field of industrial wastewater treatment.

The power source of ultrasonic degradation is acoustic cavitation. When ultrasonic waves with sufficient intensity (15 kHz-20 MHz) pass through the aqueous solution, the amplitude of the sound pressure exceeds the static pressure inside the liquid during the half cycle of the acoustic wave negative pressure, and the cavitation nucleus in the liquid expands rapidly. In the half-cycle of the positive acoustic pressure, the bubble burst again due to adiabatic compression, and the duration is about 0.1 μs. At the moment of rupture, a local high temperature and high pressure environment of about 5000K and 100 MPa is generated, and a strong impact microjet with a velocity of 110 m/s is generated. The mechanism of dual-frequency composite ultrasound is mainly that multiple frequencies of ultrasound can reduce dead spots, and the treated object is subjected to a uniform ultrasonic field, which synergistically enhances the cavitation effect, mechanical effect and thermal effect. The synergistic effect promotes the degradation efficiency of phenol, and the degradation conditions are mild. It has fast degradation conditions and a wide range of applications. It is a new technology with great development potential and application prospects.

### BRIEF DESCRIPTION OF THE DRAWINGS

In order to explain the embodiments of the present invention or the technical solutions in the prior art more clearly, the following will briefly introduce the drawings needed in the embodiments. Obviously, the drawings in the following description are only some embodiments of the present invention. Embodiments, for those of ordinary skill in the art, without creative work, other drawings can be obtained from these drawings.

FIG. 1 shows the effect of ultrasonic power on the degradation of phenol by a single probe-type ultrasound;

FIG. 2 shows the effect of phenol solution concentration on the degradation of phenol by the single probe-type ultrasound;

FIG. 3 shows the effect of phenol solution pH on the degradation of phenol by the single probe-type ultrasound;

FIG. 4 shows the effect of ultrasonic power on the degradation of phenol by a single tank-type ultrasound;

FIG. 5 shows the effect of phenol solution concentration on the degradation of phenol by the single tank-type ultrasound;

FIG. 6 shows the effect of phenol solution pH on the degradation of phenol by the single tank-type ultrasound;

FIG. 7 shows the effect of ultrasonic power on the degradation of phenol by a dual-frequency composite ultrasound;

FIG. 8 shows the effect of phenol solution concentration on the degradation of phenol by the dual-frequency composite ultrasound;

FIG. 9 shows the effect of phenol solution pH on the degradation of phenol by the dual-frequency composite ultrasound.

### DETAILED DESCRIPTION

The technical solutions in the embodiments of the present invention will be clearly and completely described below in conjunction with the accompanying drawings in the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

In order to make the above-mentioned objects, features and advantages of the present invention more obvious and easy to understand, the present invention will be further described in detail below in conjunction with the accompanying drawings and specific embodiments.

The present invention provides a method for degrading phenol in industrial wastewater with a dual-frequency composite ultrasound, wherein a phenol solution to be degraded is subjected to ultrasonic treatment for 10-30 minutes, and the ultrasonic treatment is performed with the dual-frequency composite ultrasound.

In the above technical solution, the dual-frequency composite ultrasound is a combination of a probe-type ultrasound and a tank-type ultrasound, and the probe-type ultrasound and the tank-type ultrasound simultaneously emit ultrasonic waves toward each other, so that an ultrasonic wave with multiple frequencies is formed to act on the target substance.

In the above technical solution, a power of the probe-type ultrasound is 40-600 W, preferably 40-200 W; a power of the tank-type ultrasonic power is 40-600 W, preferably 120-200 W.

In the above technical solution, an initial concentration of the phenol solution to be degraded is 2.00-10.00 mg/L; an initial pH of the phenol solution to be degraded is 8-12.

In the above technical solution, an initial pH of the phenol solution to be degraded is adjusted by adding a pH regulator; the pH regulator is a sodium hydroxide solution or a sulfuric acid solution.

The invention process and specific embodiments of the present invention are further explained below.

A multi-frequency composite ultrasonic experimental device used in the embodiments of the present invention is a combination of a tank-type ultrasound and a probe-type ultrasound. The probe-type ultrasound and the tank-type ultrasound can simultaneously emit ultrasonic waves toward each other, so that an ultrasonic wave with multiple frequencies is formed to act on the target substance. In the embodiments of the present invention, a fixed frequency of the tank-type ultrasound is 40 kHz and the power thereof is adjustable, and a fixed frequency of the probe-type ultrasound is 25 kHz and the power thereof is adjustable.

The phenol solutions used in the embodiments of the present invention were all prepared by the national standard method.

The following describes the effects of three factors (power, concentration, pH) in the ultrasonic treatment on the degradation of phenol, which are divided into three parts, namely the use of the probe-type ultrasound alone, the tank-type ultrasound alone, and the dual-frequency composite ultrasound to degrade phenol, so as to seek optimal process parameters for the ultrasonic degradation of phenol.

### Example 1 Influencing Factors of a Probe-Type Ultrasound on Degradation of Phenol

1.1 Influence of an Ultrasonic Power

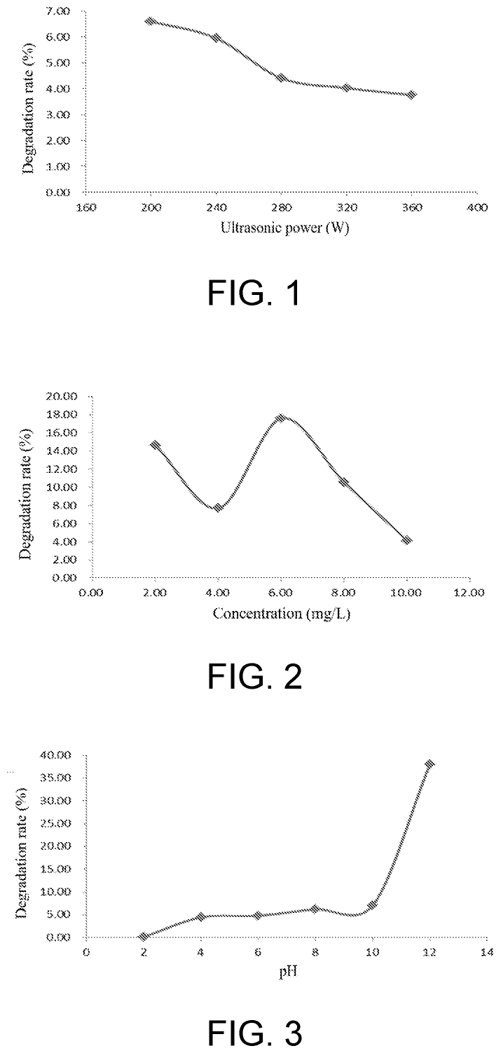

The ultrasonic power was adjusted to 200 W, 240 W, 280 W, 320 W, 360 W, and then 80 mL of a 4 mg/L phenol solution was taken into a 150 mL beaker, and treated with the probe-type ultrasound for 20 minutes. The experimental results are shown in FIG. 1.

It can be seen from FIG. 1 that as the ultrasonic power increases, the degradation rate of phenol decreases. When the power is 200 W and 360 W, the corresponding degradation rates are 6.59% and 3.75%. The possible reason is that: when the ultrasonic power reaches a certain level, the cavitation bubble grows too large, causing the cavitation bubble to collapse before it is compressed. In addition, when the sound energy is too large, and when the negative phase of the sound wave is too large to inhibit the formation of cavitation bubbles, the cavitation bubbles will form a shielding effect, which will reduce the available sound energy of the system and reduce the degradation rate.

1.2 Influence of an Initial Concentration

An phenol solution was precisely drawn in sequence to prepare phenol solutions to be treated with initial concentrations of 2.00, 4.00, 6.00, 8.00, and 10.00 mg/L. 80 mL of the phenol solution to be treated was measured with a graduated cylinder, added into a 150 mL beaker, and treated by the probe-type ultrasound at a power of 200 W for 20 minutes, and the result is shown in FIG. 2.

It can be seen from FIG. 2 that the degradation rate reaches the maximum at 6.00 mg/L, which is 17.59%. When the initial concentration is greater than 6.00 mg/L, the degradation rate decreases. It can be seen that due to the low initial concentration of phenol, the proportion of the phenol after degradation in the total amount will increase.

1.3 Influence of pH

H₂SO₄ solution and NaOH solution were used to adjust a pH of the phenol solution to 2, 4, 6, 8, 10, 12. 80 mL of a phenol solution was measured with a graduated cylinder, added to a 150 mL beaker, and treated by the ultrasound at a power of 200 W for degradation for 20 minutes. The result is shown in FIG. 3.

It can be seen from FIG. 3 that the effect of degradation enhances with the pH increasing. When the pH is 2, the degradation rate is only 0.11%, and when the pH is 12, the degradation rate reaches 38.00%. Obviously, the phenol removal rate is higher under alkaline conditions, and the degradation effect is better. The reason is that: the phenol solution is an acidic solution. Under alkaline conditions, the phenolic hydroxyl groups of phenol are more likely to enter the cavitation bubble interface area and be oxidized by the −OH radicals generated by cavitation, and even some phenolic hydroxyl groups can directly evaporate into cavitation bubbles to undergo high temperature pyrolysis, and thus the degradation rate increases.

According to the above experiments, pH has the greatest impact on the degradation rate, followed by the initial concentration, and power has the least impact on it. In order to achieve better degradation effects, the optimal parameters are initial concentration of 6.00 mg/L, power of 200 W and pH of 12.

80 mL of a phenol sample solution with a concentration of 6.00 mg/L was measured with a graduated cylinder and added into a 150 mL beaker, the pH was adjusted to 12, and the solution was treated by a probe-type ultrasound at a power of 200 W for 20 minutes. 3 parallel experiments were performed. The average degradation rate obtained is 38.51%.

### Example 2 Influencing Factors of a Tank-Type Ultrasound on Degradation of Phenol

2.1 Influence of an Ultrasonic Power

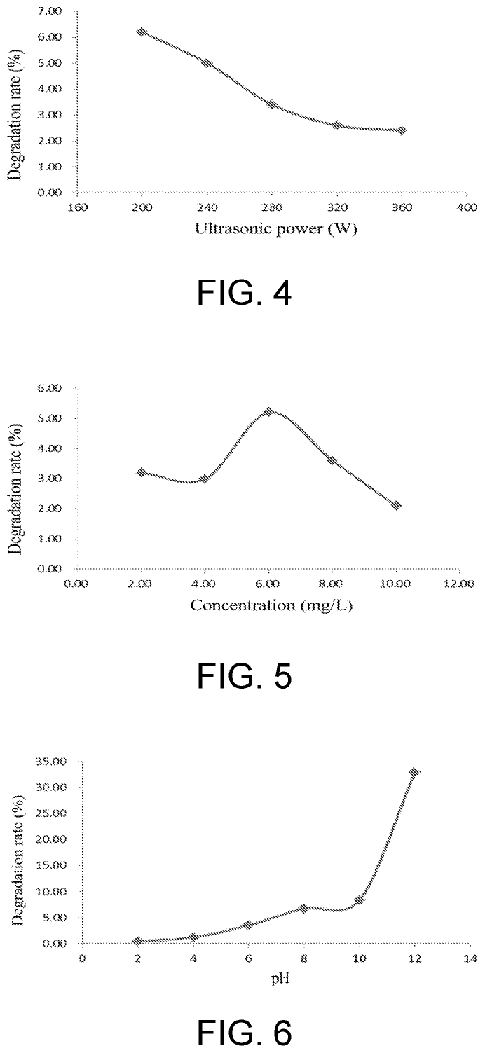

80 mL of a phenol solution with a concentration of 4 mg/L was measured with a graduated cylinder, then added into a glass test tube, and sonicated for 20 minutes under 200 W, 240 W, 280 W, 320 W, and 360 W ultrasonic power respectively. The result is shown in FIG. 4.

It can be seen from FIG. 4 that the degradation rate is 6.20% when the power is 200 W, 5.10% when the power is 240 W, and 2.40% when the power is 360 W. In general, the degradation rate of phenol is not high when using the tank-type ultrasound alone. This may be because at a certain ultrasonic power, the cavitation bubble grows too large, causing the cavitation bubble to collapse before it is compressed.

2.2 Influence of an Initial Concentration

A phenol standard intermediate solution was precisely drawn in sequence to prepare phenol solutions to be treated with initial concentrations of 2.00, 4.00, 6.00, 8.00, and 10.00 mg/L. 80 mL of the phenol solution to be treated was measured with a graduated cylinder, added into a glass test tube, and subjected to the tank-type ultrasonic treatment for 20 minutes at a power of 200 W. The result is shown in FIG. 5.

It can be seen from FIG. 5 that the initial concentration has no great effect on the degradation rate. The trend of the curve shows a downward trend, then upward and downward. When the initial concentration of phenol is 6.00 mg/L, the degradation rate is 5.76%, which is the maximum. Therefore, when sonicating phenol, the lower the concentration, the better the degradation effect, but within a certain range, the higher the initial concentration, probably the better the degradation effect.

2.3 Influence of pH

H₂SO₄ solution and NaOH solution were used to adjust a pH of the phenol solution to 2, 4, 6, 8, 10, 12. 80 mL of the phenol solution was measured with a graduated cylinder, added into a customized glass test tube and degraded for 20 minutes at a power of 200 W. The result is shown in FIG. 6.

It can be seen from FIG. 6 that when pH=2, the degradation rate is 0.47%; pH=4, the degradation rate is 1.21%; pH=6, the degradation rate is 3.52%; pH=8, the degradation rate is 6.72%; pH=10, the degradation rate is 8.31%; and pH=12, and the degradation rate is 32.79%. According to the above experiments, pH has the greatest impact on the degradation rate, followed by power, and the initial concentration has the least impact on it. In order to achieve a better degradation effect, the optimal parameters are the initial concentration of 6.00 mg/L, power of 200 W and pH of 12.

80 mL of a phenol sample solution with a concentration of 6.00 mg/L was measured with a graduated cylinder, and added into a glass test tube. The pH was adjusted to 12. The phenol sample solution was sonicated for 20 minutes at an ultrasonic power of 200 W. 3 parallel experiments were performed. The average degradation rate obtained is 32.63%.

### Example 3 Influencing Factors of a Dual-Frequency Composite Ultrasound on Degradation of Phenol

Since the dual-frequency composite ultrasound has multiple ways of combined power, in the embodiments of the present invention, the power of the tank-type ultrasound was fixed to 160 W, and only the power of the probe-type ultrasound varied in the process.

3.1 Influence of an Ultrasonic Power

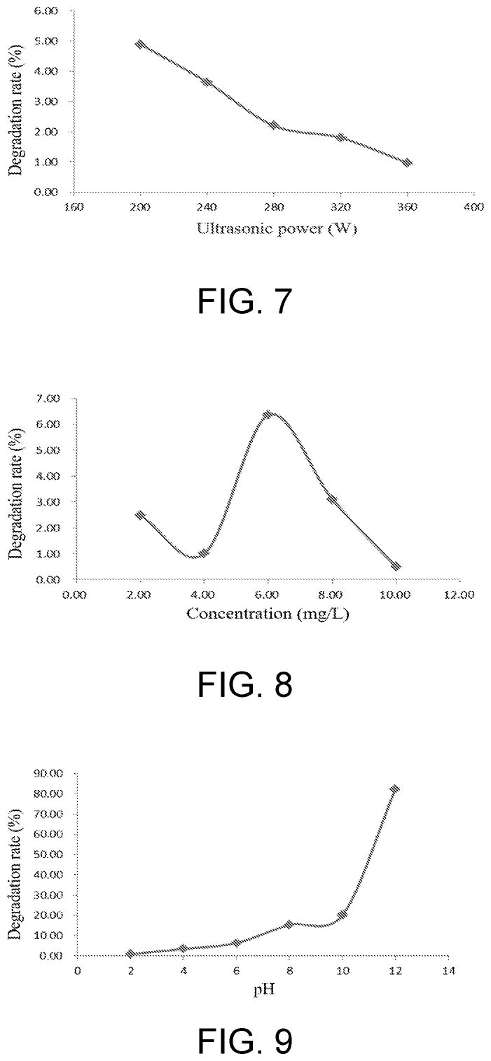

80 mL of a sample solution was measured with a graduated cylinder and added into a glass test tube. The power of the tank-type ultrasound was fixed to 160 W, and the power of the probe-type ultrasound was adjusted to 40 W, 80 W, 120 W, 160 W, 200 W. The ultrasonic treatment was carried out for 20 minutes. The result is shown in FIG. 7.

It can be seen from FIG. 7 that the degradation effect of the dual-frequency composite ultrasound decreases as the power increases. When the ultrasonic power is 200 W, the degradation rate is 4.90%, and it drops to 0.97% at 360 W.

3.2 Influence of an Initial Concentration

A phenol solution was precisely drawn in sequence to prepare phenol solutions to be treated with initial concentrations of 2.00, 4.00, 6.00, 8.00, and 10.00 mg/L. 80 mL of the phenol solution to be treated was measured with a graduated cylinder and added into a glass test tube. Ultrasonic treatment was carried out for 20 minutes under the condition that the power of the tank-type ultrasound was 160 W and the power of the probe-type ultrasound was 40 W. The result is shown in FIG. 8.

It can be seen from FIG. 8 that when the concentration is 2.00 mg/L, the degradation rate is 2.48%; when the concentration is 4.00 mg/L, it is 1.06%; when the concentration is 6.00 mg/L, it is 6.35%; when the concentration is 8.00 mg/L, Is 3.10%; when the concentration is 10.00 mg/L, it is 0.49%. It can be seen that the degradation rate first increases and then decreases with the increase of concentration.

3.3 Influence of pH

H₂SO₄ solution and NaOH solution were used to adjust a pH of the phenol solution to 2, 4, 6, 8, 10, 12. 80 mL of the phenol solution was measured with a graduated cylinder and added into a glass test tube. Ultrasonic treatment was carried out for 20 minutes under the conditions that the power of the tank-type ultrasound was 160 W and the probe-type ultrasound was 40 W. The result is shown in FIG. 9.

It can be seen from FIG. 9 that the degradation rate of the dual-frequency composite ultrasound increases with the increase of pH. When the pH is 14, the degradation rate reaches the maximum, which is 82.3%. The reason is that the phenol solution itself is acidic. During the ultrasound process, the phenol and its degraded substances react with sodium hydroxide to make the reaction continue to proceed in the direction of the positive reaction, thereby promoting the degradation of phenol.

According to the above experiments, the pH, followed by power and the initial concentration, has the least impact on the degradation rate. In order to achieve a better degradation effect, the optimal parameters are the initial concentration of 6.00 mg/L, the pH of 12, the power of the tank-type ultrasound is 160 W, and the power of the probe-type ultrasound is 80 W.

80 mL of a phenol solution with a concentration of 6.00 mg/L was taken, with the pH value of the phenol solution adjusted to 12, and sonicated for 20 minutes at a tank-type ultrasonic power of 160 W and a probe-type ultrasonic power of 80 W. Three parallel experiments were performed, and the degradation rate obtained was 83.74%.

Through the above-mentioned exploration, the probe-type ultrasonic degradation of phenol alone, the tank-type ultrasonic degradation of phenol alone, and the dual-frequency composite ultrasonic degradation of phenol were carried out under their respective optimal process conditions (that is, under the optimal conditions that the tank-type ultrasound was at 200 W, the initial concentration was 6.00 mg/L, pH was 12; under the optimal conditions that the probe-type ultrasonic power was 200 W, the initial concentration was 6.00 mg/L, and pH value was 12; under the optimal conditions that the tank-type ultrasonic power was 160 W and the probe-type ultrasonic power was 80 W, the initial concentration of phenol was 6.00 mg/L and the pH value was 12). It can be known from the degradation rate of phenol that the degradation rate of phenol by dual-frequency composite ultrasound is higher than that of the probe-type ultrasound alone and the tank-type ultrasound alone, increased by 45.23% and 51.11% respectively. Therefore, it can be clearly seen that the degradation effect of dual-frequency composite ultrasonic synergistic degradation of phenol in water is ideal.

The above-mentioned embodiments only describe the preferred modes of the present invention, and do not limit the scope of the present invention. Without departing from the design spirit of the present invention, various modification and improvement made to the technical solutions of the present invention by those of ordinary skill in the art shall fall within the protection scope determined by the claims of the present invention.

What is claimed is:

1. A method for degrading phenol in industrial wastewater with a dual-frequency composite ultrasound, comprising: a phenol solution to be degraded is subjected to an ultrasonic treatment for 10-30 minutes, wherein the ultrasonic treatment is performed with the dual-frequency composite ultrasound.

2. The method for degrading phenol in industrial wastewater with the dual-frequency composite ultrasound according to claim 1, wherein the dual-frequency composite ultrasound is a combination of a probe-type ultrasound and a tank-type ultrasound, and the probe-type ultrasound and the tank-type ultrasound are emitted in a direction opposite to each other at the same time.

3. The method for degrading phenol in industrial wastewater with the dual-frequency composite ultrasound according to claim 2, wherein a power of the probe-type ultrasound is 40-600 W.

4. The method for degrading phenol in industrial wastewater with the dual-frequency composite ultrasound according to claim 2, wherein a power of the tank-type ultrasound is 40-600 W.

5. The method for degrading phenol in industrial wastewater with the dual-frequency composite ultrasound according to claim 1, wherein an initial concentration of the phenol solution to be degraded is 2.00-10.00 mg/L.

6. The method for degrading phenol in industrial wastewater with the dual-frequency composite ultrasound according to claim 1, wherein an initial pH of the phenol solution to be degraded is 8-12.

7. The method for degrading phenol in industrial wastewater with the dual-frequency composite ultrasound according to claim 6, wherein the initial pH of the phenol solution to be degraded is adjusted by adding a pH regulator.

8. The method for degrading phenol in industrial wastewater with the dual-frequency composite ultrasound according to claim 7, wherein the pH regulator is a sodium hydroxide solution or a sulfuric acid solution.
